(19) United States
(12) Patent Application Publication
(10) Pub. No.: US 2014/0356112 A1
(43) Pub. Date: Dec. 4, 2014

(54) APPARATUS AND METHODOLOGY THAT FACILITATES MOBILIZING HEAVY EQUIPMENT

(71) Applicant: Lawrence Garcia, Fresno, CA (US)

(72) Inventor: Lawrence Garcia, Fresno, CA (US)

(21) Appl. No.: 14/290,968

(22) Filed: May 29, 2014

Related U.S. Application Data
(60) Provisional application No. 61/828,676, filed on May 29, 2013.

(51) Int. Cl. B60P 1/44

(52) U.S. Cl. CPC B60P 1/4485
USPC 414/399; 414/809

(57) ABSTRACT

An apparatus is disclosed which includes a bed coupled to extendible legs that extend away from the bed. The extendible legs comprise lift the bed to a desired height level, whereas the bed attaches to a vehicle and facilitates transferring weight from the extendible legs to a vehicle attachment component on the bed. A vehicle is also disclosed, which includes extendible arms, which extend away from an arm housing component. The extendible arms attach to a load and hold the load in a suspended position. In another aspect, a method is disclosed which includes ascertaining parameters associated with loading a load onto a vehicle and determining a placement configuration of an arm component onto the vehicle according to the parameters. The arm component attaches to the vehicle according to the placement configuration and facilitates holding the load in a suspended position.

### CROSS-REFERENCE TO RELATED APPLICATIONS

This application claims priority to and the benefit of provisional patent application No. 61/828,676, filed in the United States Patent and Trademark Office on May 29, 2013, the entire content of which is incorporated herein by reference.

### TECHNICAL FIELD

The subject disclosure generally relates to the mobilization of heavy equipment, and more specifically to facilitating an efficient mobility of heavy equipment between a vehicle and a desired location.

### BACKGROUND

By way of background concerning conventional methods for mobilizing heavy equipment, it is noted that such equipment is often loaded onto the bed of a pickup truck. A refrigerator, for example, may be loaded onto the bed of a pick up truck and transported from one location to another. To this end, although a dolly may be used to roll the refrigerator towards the truck, lifting the refrigerator onto the bed from ground level is a laborious act that often requires multiple people.

Accordingly, it would be desirable to provide an apparatus and methodology which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide methods and apparatuses directed towards mobilizing a load. In one aspect, the disclosure provides an apparatus to facilitate mobilizing a load, which includes a bed coupled to extendible legs. Within such embodiment, the extendible legs are configured to extend away from the bed in a first position and collapse towards the bed in a second position. Here, the extendible legs comprise a lift component configured to facilitate a lifting of the bed to a desired height level, whereas the bed comprises a vehicle attachment component configured to attach to a vehicle. The vehicle attachment component is further configured to facilitate a transfer of weight of the apparatus from the extendible legs to the vehicle attachment component.

In another aspect, a vehicle is disclosed, which includes an extendible arm component coupled to an arm housing component configured to house the extendible arm component. Within such embodiment, the extendible arm component comprises at least one extendible arm configured to extend away from the arm housing component in a first position and retract into the arm housing component in a second position. The at least one extendible arm is further configured to attach to a load and facilitate holding the load in a suspended position.

In yet another aspect, a method to facilitate mobilizing a load is disclosed. The method includes ascertaining parameters associated with loading the load onto a vehicle and determining a placement configuration of an arm component onto the vehicle according to the parameters. Within such embodiment, the arm component includes at least one arm housing unit and at least one extendible arm. The method further includes attaching the arm component onto the vehicle according to the placement configuration, such that the attaching facilitates holding the load in a suspended position from the arm component.

These and other disclosed aspects will become more fully understood upon a review of the detailed description, which follows. Other aspects, features, and aspects of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

Various non-limiting embodiments are further described with reference to the accompanying drawings in which:

FIG. 1 is a schematic of an exemplary apparatus that facilitates mobilizing heavy equipment in accordance with an aspect of the subject specification;

FIG. 2 is a block diagram of an exemplary apparatus that facilitates mobilizing heavy equipment in accordance with an aspect of the subject specification;

FIG. 3 is a schematic of a first view of an exemplary vehicle that facilitates mobilizing heavy equipment in accordance with an aspect of the subject specification;

FIG. 4 is a schematic of a second view of an exemplary vehicle that facilitates mobilizing heavy equipment in accordance with an aspect of the subject specification;

FIG. 5 is a block diagram of an exemplary vehicle that facilitates mobilizing heavy equipment in accordance with an aspect of the subject specification;

FIG. 6 is a flow diagram of an exemplary methodology that facilitates mobilizing heavy equipment in accordance with an aspect of the subject specification;

FIG. 7 illustrates an exemplary apparatus having a gurney-like design in a lowered position in accordance with an aspect of the subject specification;

FIG. 8 illustrates an exemplary apparatus having a gurney-like design in a raised position in accordance with an aspect of the subject specification;

FIG. 9 illustrates an exemplary apparatus having a gurney-like design in a suspended position in accordance with an aspect of the subject specification;

FIG. 10 illustrates an exemplary apparatus having a gurney-like design placed on a vehicle in accordance with an aspect of the subject specification;

FIG. 11 is a first view of an exemplary tool chest in a closed configuration in accordance with an aspect of the subject specification;

FIG. 12 is a second view of an exemplary tool chest in accordance with an aspect of the subject specification;

FIG. 13 is a third view of an exemplary tool chest in a work-ready configuration in accordance with an aspect of the subject specification;

FIG. 14 is a first view of an exemplary grill in a lowered configuration in accordance with an aspect of the subject specification;

FIG. 15 is a second view of an exemplary grill in a lowered configuration in accordance with an aspect of the subject specification;

FIG. 16 is a view of an exemplary grill in a raised configuration in accordance with an aspect of the subject specification;

FIG. 17 is a view of an exemplary grill in a partially raised configuration proximate to a tailgate in accordance with an aspect of the subject specification; and

FIG. 18 is a view of an exemplary grill in a fully raised configuration proximate to a tailgate in accordance with an aspect of the subject specification.

### DETAILED DESCRIPTION

Overview

As discussed in the background, mobilizing heavy equipment often involves loading such equipment onto a vehicle from ground level. The various embodiments disclosed herein are directed towards increasing the mobility of heavy equipment via methods and apparatuses configured to make loading/unloading such equipment more efficient. In a first exemplary embodiment, a gurney-like apparatus configured to transport heavy equipment is disclosed. Within such embodiment, the gurney-like apparatus may be further configured to securely lock onto the bed of a pickup truck once loaded to facilitate subsequent transport. In another exemplary embodiment, aspects are disclosed for configuring the bed of a pickup truck to receive and securely lock heavy equipment, such as the gurney-like apparatus.

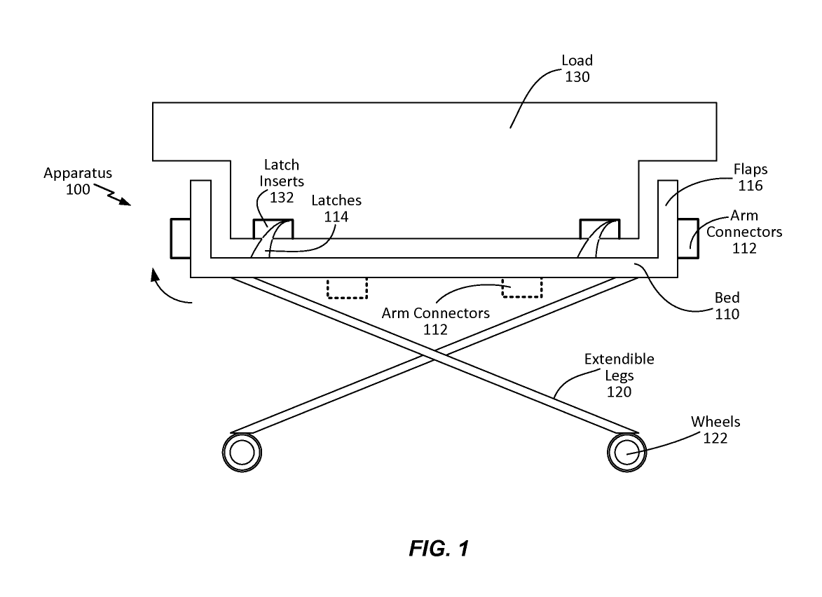

Referring first to FIG. 1, a schematic of an exemplary apparatus that facilitates mobilizing heavy equipment is provided in accordance with an aspect of the disclosure. As illustrated, apparatus 100 comprises bed 110 coupled to extendible legs 120. Within such embodiment, apparatus 100 is configured to hold load 130 via bed 110, wherein extendible legs 120 are configured to extend so as to raise and lower the height of bed 110. As illustrated, extendible legs 120 may also comprise wheels 122 so that load 130 may be easily transported between locations.

Also, in order to secure load 130 onto bed 110, it is contemplated that bed 110 may include various mechanisms to stabilize load 130. For instance, bed 110 may further comprise flaps 116 to prevent load 130 from sliding off bed 110. To this end, it should be appreciated that flaps 116 may be included on a single side of bed 110 or multiple sides of bed 110. It should be further appreciated that flaps 116 may be attached to bed 110 via a hinge so that flaps 116 may be rotated up, as illustrated, after load 130 has been placed onto bed 110. In another aspect, load 130 may be secured onto bed 110 via latches 114, as shown. Within such embodiment, bed 110 comprises any number of latches 114 which are respectively configured to latch onto load 130 via latch inserts 132.

It is further contemplated that apparatus 100 may be configured to include a mechanism to facilitate loading apparatus 100 onto a vehicle. In a particular aspect, as is discussed in further detail below, apparatus 100 is configured to be loaded onto a vehicle via extendible arms that extend outward from a vehicle and mate with apparatus 100 via arm connectors 112. As illustrated, it is contemplated that arm connectors 112 may be included on flaps 116 and/or a bottom portion of bed 110.

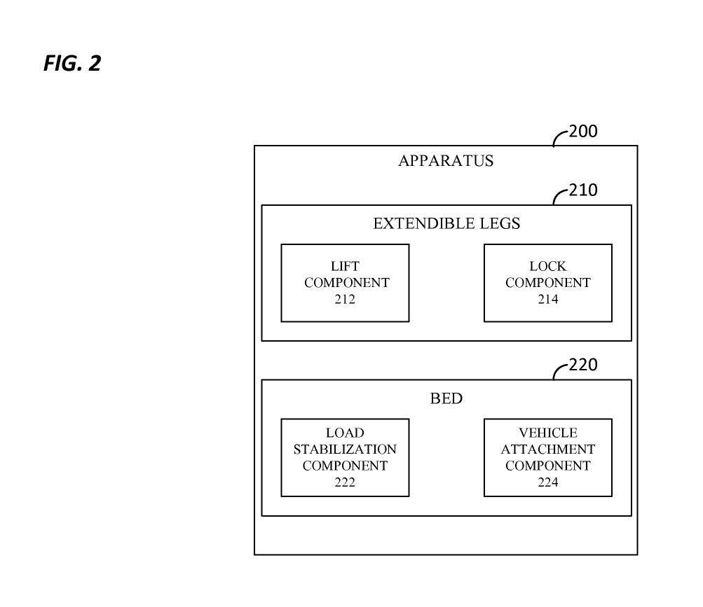

Referring next to FIG. 2, a block of an exemplary apparatus that facilitates mobilizing heavy equipment is provided in accordance with an aspect of the disclosure. As illustrated, apparatus 200 comprises extendible legs 210 and bed 220. Within such embodiment, extendible legs 210 are coupled to bed 220 and configured to extend away from, and collapse towards, bed 220. In a particular aspect, extendible legs 210 comprise lift component 212, which is configured to facilitate a lifting of bed 220 to a desired height level, whereas bed 220 comprises vehicle attachment component 224 configured to attach to a vehicle (e.g., arm connectors 112). Here, it is contemplated that vehicle attachment component 224 is further configured to facilitate a transfer of weight of apparatus 200 from extendible legs 210 to vehicle attachment component 224. Namely, upon mating with arms extended from a vehicle, it is contemplated that vehicle attachment component 224 will be designed to support the weight of apparatus 200 while it is suspended in air (i.e., once extendible legs 210, while in a raised and extended position, collapse towards bed 220 away from the ground), which may include the weight of a load placed on bed 220.

Because it is anticipated that apparatus 200 may be used in conjunction with heavy loads, aspects disclosed herein include mechanisms that facilitate extending extendible legs 210 with minimal effort when a heavy load is placed on bed 220. To this end, it is contemplated that lift component 212 may be configured to include any of various systems to facilitate such heavy lifting. For instance, it is contemplated that lift component 212 may be configured to include a hydraulic lift system, a manual crank system, a spring system, and/or any of various other lift systems known in the art.

As mentioned previously, because it may be desirable to secure a load onto bed 220, it is contemplated that bed 220 may further include load stabilization component 222 to stabilize such load. For instance, load stabilization component 222 may comprise foldable flaps (e.g., flaps 116) configured to block a slippage of the load. Alternatively, or in addition to such flaps, load stabilization component 222 may comprise latches (e.g., latches 114) which are respectively configured to latch onto the load, as mentioned previously.

As illustrated, extendible legs 210 may also comprise lock component 214. Within such embodiment, lock component 214 is configured to lock extendible legs 210 in at least one of a first position (e.g., a lowered height where extendible legs 210 are collapsed) or a second position (e.g., a raised height where extendible legs 210 are extended). To this end, it is further contemplated that lock component 214 may also be configured to lock extendible legs 210 into any of various intermediate positions as well. Lock component 214 may also be configured to lock extendible legs 210 while extendible legs 210 are in a suspended position (i.e., when apparatus 200 is attached to the extendible arms of a vehicle and suspended in air).

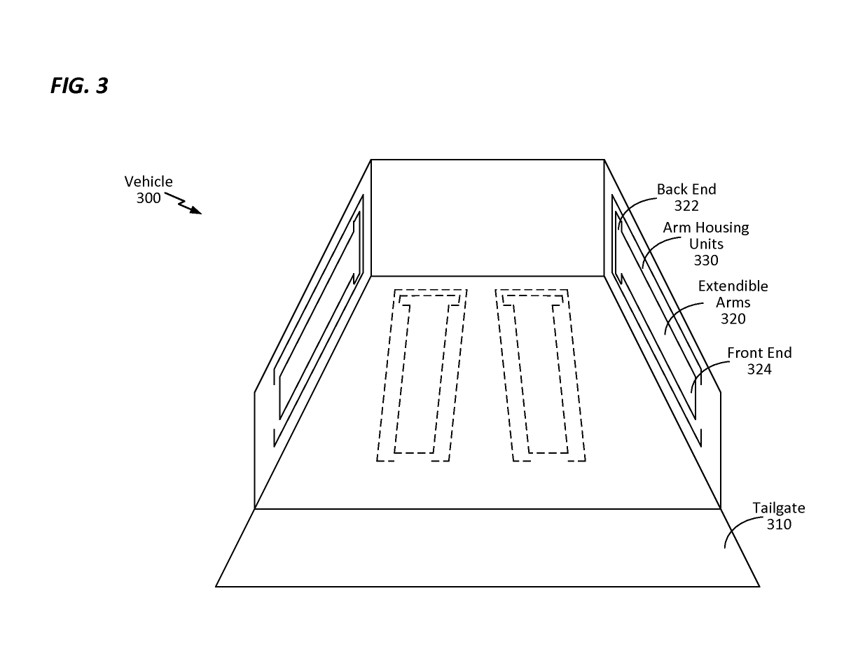

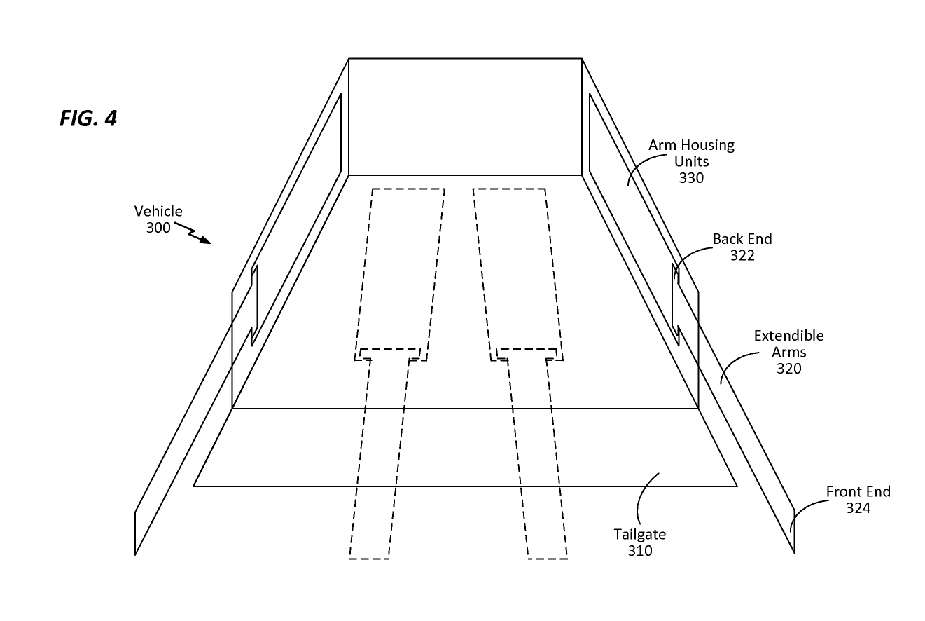

Referring next to FIGS. 3-4, a first and second view of an exemplary vehicle that facilitates mobilizing heavy equipment is provided in accordance with an aspect of the disclosure. As illustrated, vehicle 300 may be pickup truck with tailgate 310, and configured to include extendible arms 320 housed within arm housing units 330. In FIG. 3, extendible arms 320 are shown in a retracted position, wherein extendible arms 320 are housed substantially within arm housing units 330, whereas FIG. 4 shows extendible arms 320 in an extended position substantially outside of arm housing units 330. Here, it should be appreciated that extendible arms 320 and corresponding arm housing units 330 may be placed either on a side portion of vehicle 300, and/or on an inner portion of vehicle 300, as shown. It should be further appreciated that a locking mechanism may be included to lock extendible arms 320 in any of a plurality of positions including an extended position, a retracted position, and/or any intermediate position. For instance, either of back end 322 and/or front end 324 may be configured to firmly lock onto arm housing units 330.

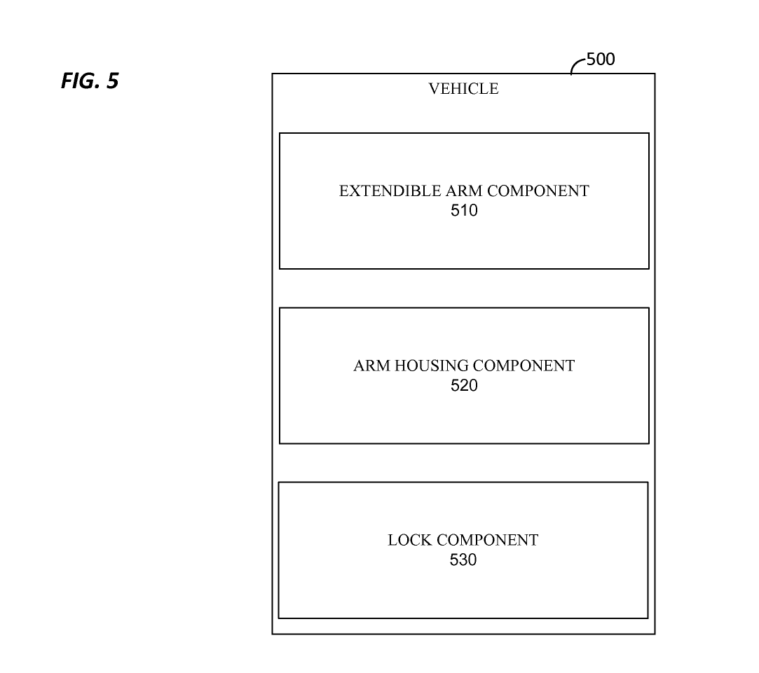

Referring next to FIG. 5, a block diagram of an exemplary vehicle that facilitates mobilizing heavy equipment is provided in accordance with an aspect of the disclosure. As illustrated, vehicle 500 comprises extendible arm component 510, arm housing component 520, and lock component 530. Within such embodiment, extendible arm component 510 (e.g., extendible arms 320) is coupled to arm housing component 520 (e.g., arm housing units 330) configured to house extendible arm component 510. Within such embodiment, extendible arm component 510 comprises at least one extendible arm configured to extend away from arm housing component 520 in a first position and retract into arm housing component 520 in a second position.

In an aspect, the disclosed extendible arm is configured to attach to a load and facilitate holding the load in a suspended position. Here, it is contemplated that such extendible arm may be configured to attach to a load in any of a plurality of ways. For instance, the extendible arm may be configured to mate with an attachment mechanism on the load (e.g., via arm connectors 112). Within such embodiment, the extendible arm may include a male insert configured to mate with the attachment mechanism on the load. Alternatively, the extendible arm may include a female receptor configured to mate with the attachment mechanism on the load.

In another aspect, lock component 530 may be configured to lock the extendible arms in any of a plurality of positions including an extended position, a retracted position, and/or any intermediate position. For instance, as mentioned previously, either of a back end and/or front end of the extendible arms may be configured to firmly lock onto a corresponding arm housing unit.

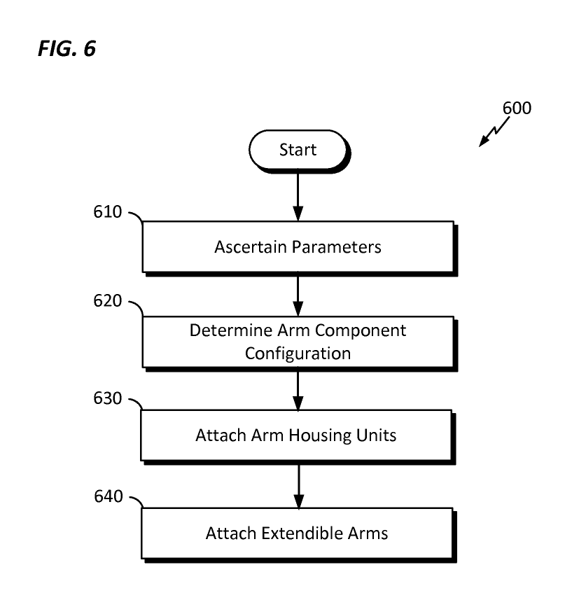

Referring next to FIG. 6, a flow diagram of an exemplary methodology that facilitates mobilizing heavy equipment is provided in accordance with an aspect of the disclosure. Here, it should be appreciated that such process may be implemented so as to customize a vehicle, such as the bed of a truck, to utilize the aspects disclosed herein. As illustrated, process 600 begins at act 610 where parameters associated with loading a load onto a vehicle are ascertained. Such parameters may include load-specific specifications (e.g., load dimension ranges, load weight range, etc.), as well as vehicle-specific specifications (e.g., bed dimensions, weight limits, etc.). Next, process 600 continues at act 620 by determining a placement configuration of an arm component (e.g., extendible arms 320 and arm housing units 330) onto the vehicle according to the parameters ascertained in act 610. For instance, such determination may include placing the arm component in an inner portion of the vehicle, if retrieved parameters indicate that such vehicle's wheel wells would obstruct placing the arm component on a side portion of the vehicle. Process 600 then proceeds to act 630 where arm housing units are attached to the vehicle followed by an attachment of the extendible arms at act 640, such that the attaching facilitates holding a load in a suspended position from the arm component.

### EXEMPLARY EMBODIMENTS

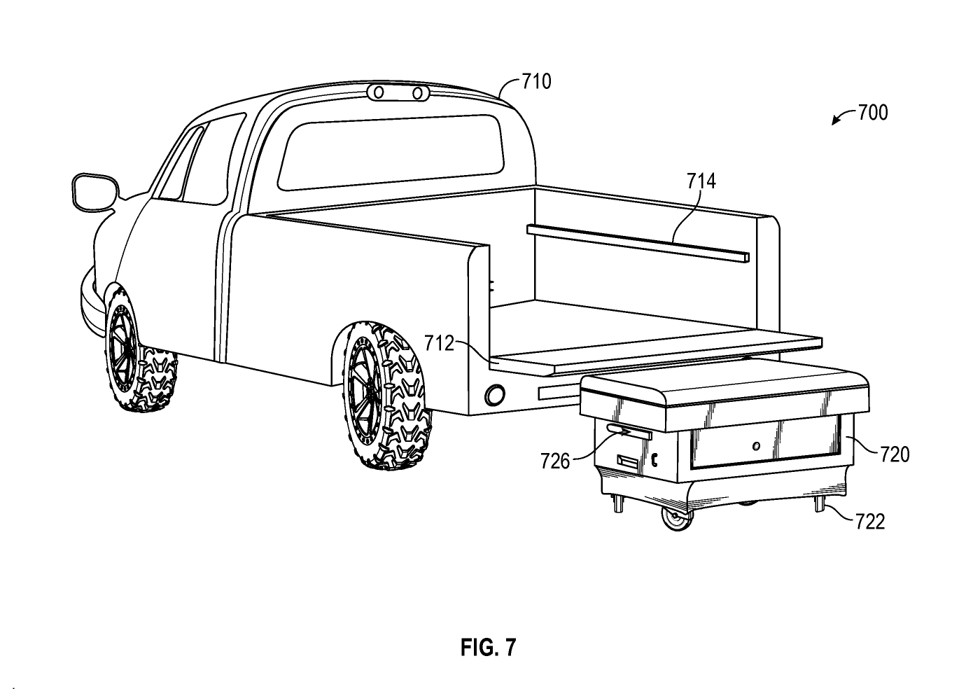

Turning now to FIG. 7, an exemplary view of an apparatus configured to mobilize heavy equipment in accordance with an aspect of the subject specification is provided. As illustrated in this exemplary view 700, it is contemplated that apparatus 720 may be configured to transport heavy equipment to and from vehicle 710, wherein apparatus 720 may also be configured to securely lock onto vehicle 710 to facilitate further transport. In an exemplary scenario for using apparatus 720, it is noted that although pickup trucks are often used to transport tools to a location proximate to a worksite, subsequently transporting the tools to the actual worksite from the truck is laborious. And since workers are often unsure of exactly what tools will be needed for a particular job, it is desirable for them to simply have all/most of their tools at the worksite, rather than having to make multiple trips between the truck and the worksite. For such scenario, apparatus 720 may thus be configured to function as a mobile tool chest, wherein tools are transported to and from vehicle 710 by rolling apparatus 720 along wheels 722.

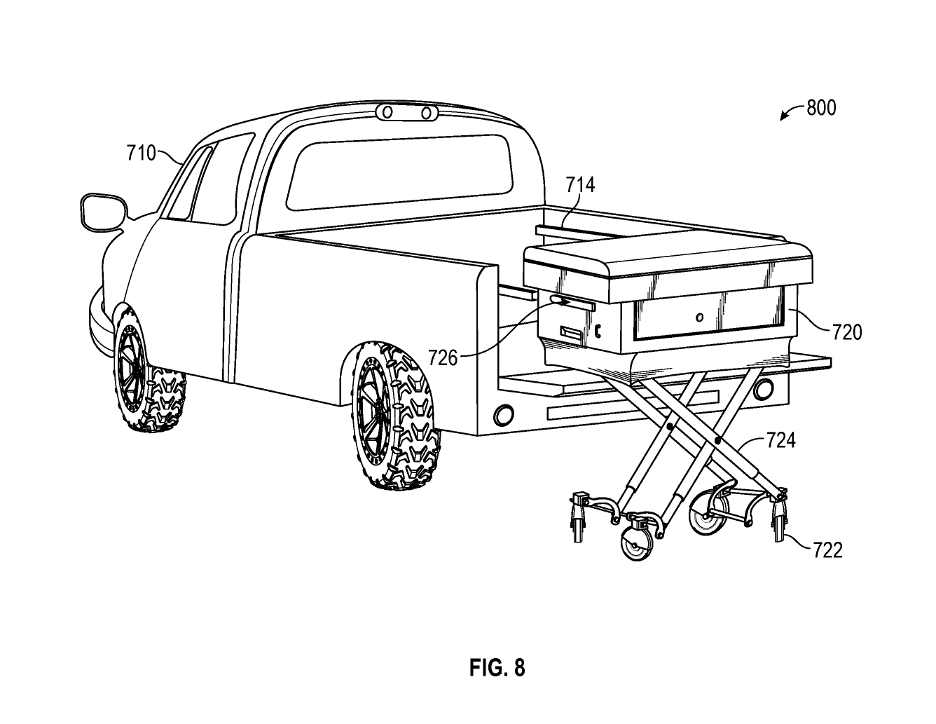

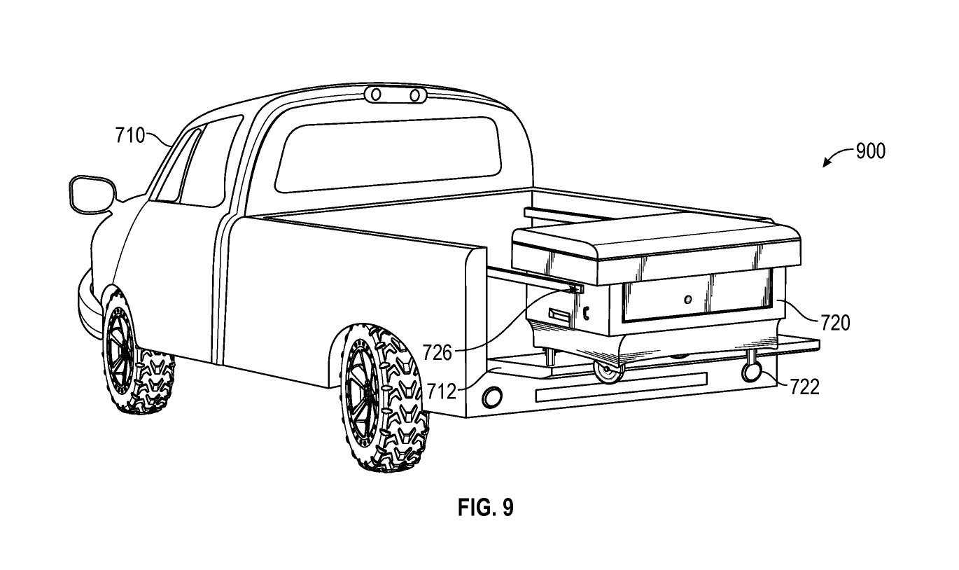

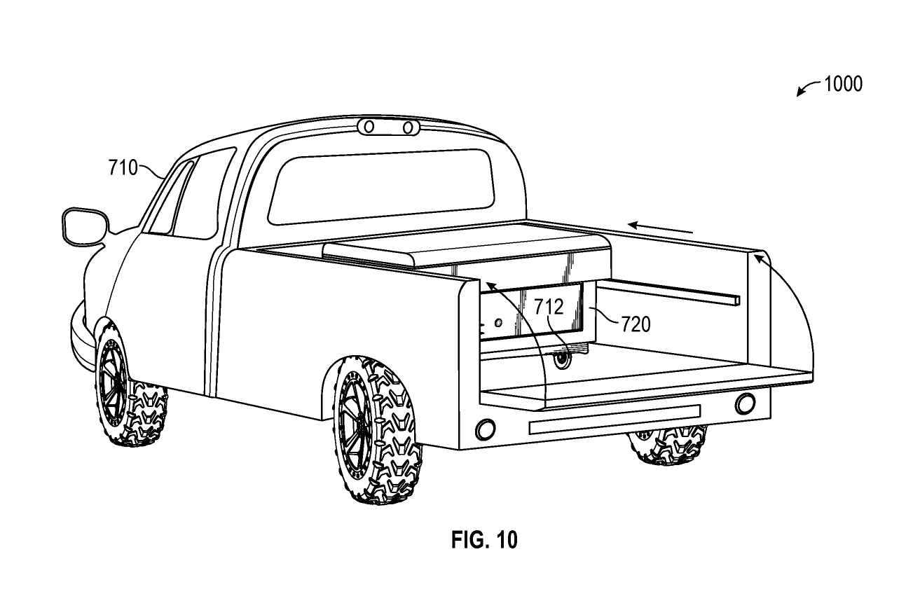

Since it is contemplated that vehicle 710 may be a pickup truck, various embodiments directed towards loading apparatus 720 onto a pickup truck from ground level are also disclosed. In FIG. 8, a gurney-like design is provided as an exemplary embodiment to facilitate such loading. For this embodiment, view 800 shows apparatus 720 configured as a gurney-like apparatus comprising wheels 722 and extendible legs 724, as shown. In an exemplary loading sequence, apparatus 720 may first be rolled towards the rear of vehicle 710, wherein extendible legs 724 are then raised so that the body of apparatus 720 clears tailgate 712, as shown. Once extended, arm connectors 726 on either side of apparatus 720 are respectively lined up with extendible arms 714 which are configured to extend out from vehicle 710. Apparatus 720 is then rolled towards vehicle 710 so that extendible arms 714 mate with arm connectors 726. Once apparatus 720 is firmly attached to extendible arms 714, extendible legs 724 may be collapsed upward towards the body of apparatus 720 so that they vertically clear tailgate 712, as shown in view 900 illustrated in FIG. 9. Here, upon collapsing extendible legs 724, apparatus 720 is held in midair, wherein support for the weight of apparatus 720 is transferred from wheels 722 to extendible arms 714. Apparatus 720 can then be slid over tailgate 712 and into the bed of vehicle 710, wherein extendible arms 714 are reinserted into the sides of vehicle 710 as apparatus 720 is slid into the bed, as shown in view 1000 illustrated in FIG. 10. A locking mechanism can then be engaged to securely hold apparatus 720 in place within the bed of vehicle 710 during transit (e.g., via a latch configured to prevent apparatus 720 from sliding further along extendible arms 714).

When unloading apparatus 720 from vehicle 710, it should be appreciated that a reversal of the aforementioned steps for loading apparatus 720 may be followed. For instance, apparatus 720 may first be unlocked/unlatched, which allows apparatus 720 to slide along extendible arms 714. Tailgate 712 can then be lowered, which allows apparatus 720 to be slid beyond tailgate 712 and held in midair by extendible arms 714. Namely, as apparatus 720 slides away from vehicle 710, extendible arms 714 begin to extend which allow them to support the weight of apparatus 720 beyond tailgate 712. Once apparatus 720 has been slid past tailgate 712, extendible legs 724 may be extended downward away from the body of apparatus 720 so as to facilitate a transfer of support for the weight of apparatus 720 from extendible arms 714 to wheels 722. Upon wheels 722 making contact with the ground (or being proximate to the ground), apparatus 720 may be slid off of extendible arms 714 and rolled to a desired location.

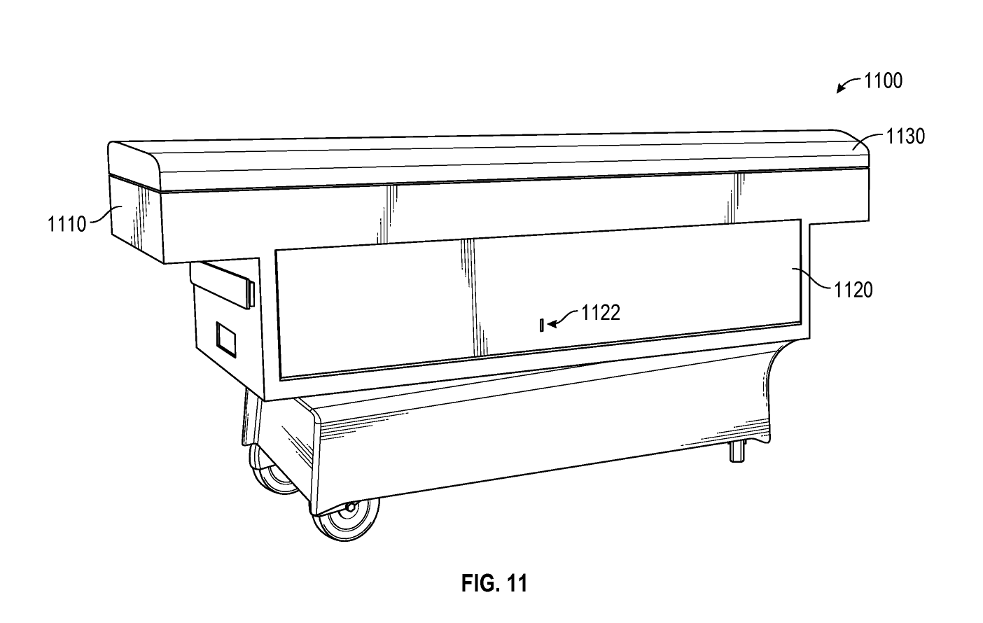

As stated previously, various embodiments directed towards a mobile tool chest are contemplated which facilitate transporting tools to and from a vehicle. Referring next to FIGS. 11-13, exemplary illustrations of such a mobile tool chest are provided. In FIG. 11, for example, a first view 1100 of tool chest 1110 is shown as being substantially similar to apparatus 720, wherein tool chest 1110 may include additional features specifically directed towards contemplated tool chest usage. For instance, view 1100 shows tool chest 1110 in a closed configuration, which may be particularly desirable for security reasons. Namely, because tool chest 1110 may be configured as a tool chest that is mobile and readily retractable from a vehicle, embodiments for securely storing tools within tool chest 1110 at various locations are contemplated (e.g., securely storing such tools while in the bed of a parked vehicle, at a worksite, etc.). In a particular embodiment, tools may be securely stored behind security door 1120 and/or beneath top door 1130, as shown. For additional security, security door 1120 and/or top door 1130 may be configured to include a locking mechanism, such as lock 1122.

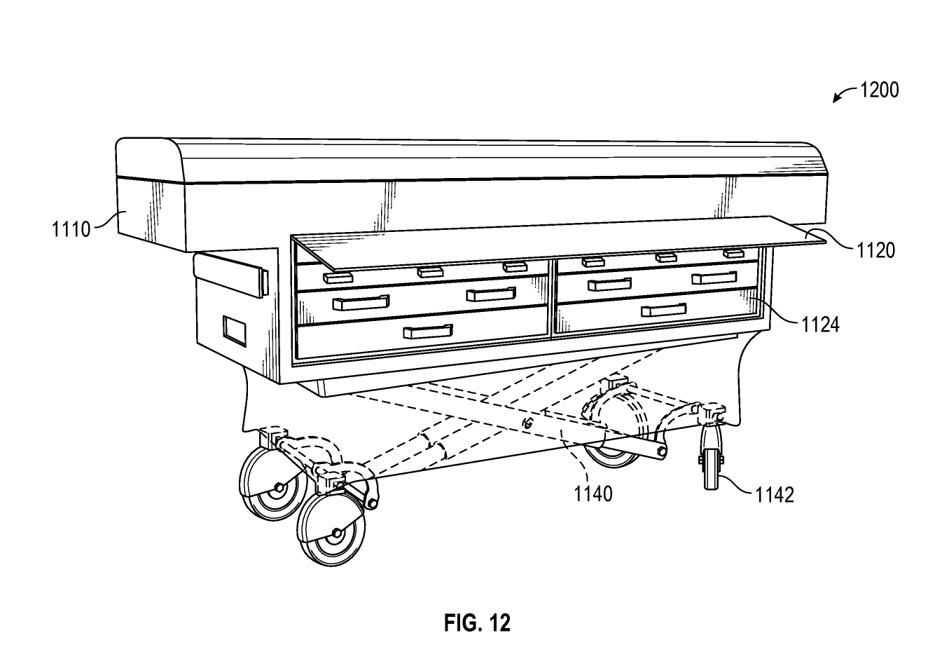

Referring next to FIG. 12, another exemplary view 1200 of tool chest 1110 is provided. As illustrated, security door 1120 may be configured to lift up so as to provide access to drawers 1124. In an aspect, a plurality of drawers 1124 may be included and configured to store any of various tools/equipment. View 1200 also illustrates how tool chest 1110 may be configured according to a gurney-like design similar to apparatus 720, wherein tool chest 1110 includes extendible legs 1140 and wheels 1142. To this end, it should be appreciated that tool chest 1110 may be configured to perform functions substantially similar to those performed by apparatus 720. Moreover, it should be appreciated that tool chest 1110 may be configured to be loaded/unloaded onto a vehicle in any of a plurality of ways, including via the aforementioned steps described for apparatus 720.

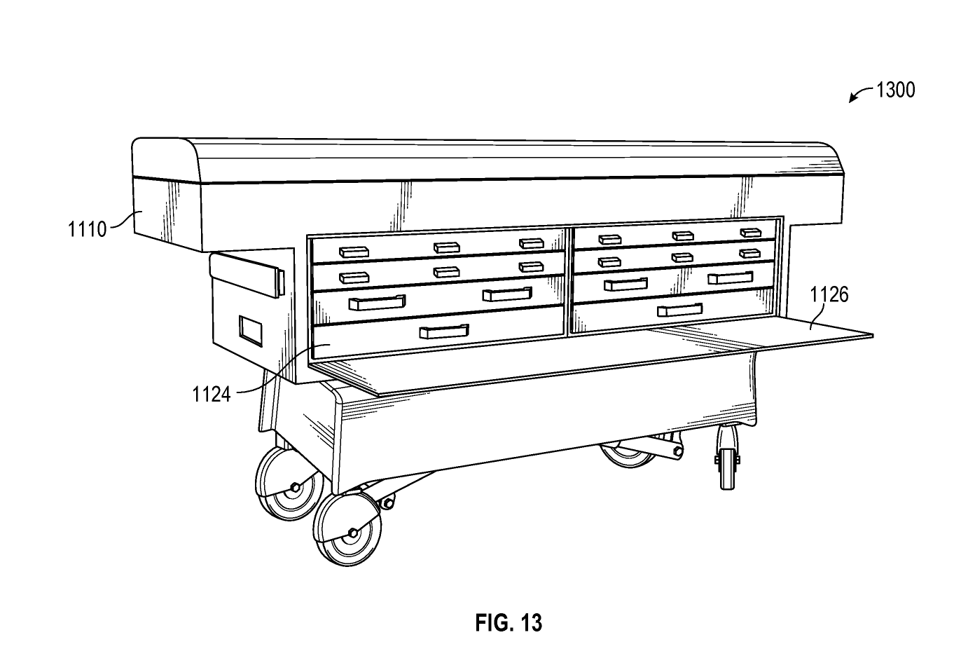

Since it is anticipated that tool chest 1110 will be used at a worksite, tool chest 1110 may be further configured to include various additional features to facilitate such use. In FIG. 13, for instance, yet another exemplary view 1300 of tool chest 1110 is provided which illustrates some of those features. In a particular aspect, security door 1120 is configured to be inserted within tool chest 1110 so as to not obstruct access to drawers 1124. As illustrated, to further facilitate using tool chest 1110 at a worksite, workbench 1126 may be included. Within such embodiment, workbench 1126 may be configured to be extend outward from below drawers 1124, as shown, so as to provide a sturdy work area. Once a user is finished at a worksite and wishes to load tool chest back onto a vehicle, workbench 1126 may be reinserted into tool chest 1110 and security door 1120 may be lowered to cover drawers 1124.

Although a tool chest embodiment is disclosed above, it should nevertheless be appreciated that the aspects disclosed herein also encompass methods and apparatuses configured to transport various other items that may be bulky and/or heavy. For instance, rather than configuring the upper portion of apparatus 720 as a tool chest, the upper portion may simply be configured to include arm connectors 726 on either side of the upper portion. Indeed, within such embodiment, a bulky/heavy object (e.g., large television, heavy appliance, barbecue grill, etc.) can be placed between the side walls of an upper portion of apparatus 720. Apparatus 720 can be further configured to include a mechanism for securing the bulky/heavy object onto apparatus 720 (e.g., a strapping mechanism). Once secured onto apparatus 720, the bulky/heavy object can be loaded onto a vehicle according to the aspects disclosed herein.

It should be further appreciated that, although the aspects disclosed herein describe various exemplary embodiments with particular configurations, other embodiments having different configurations also fall within the scope and spirit of the present disclosure. For instance, although a gurney-like design has been disclosed, one of ordinary skill will appreciate that other lift mechanisms can also be implemented (e.g., a hydraulic lift system rather than, or in conjunction with, extendible legs). It is also contemplated that, rather than having an arm connector on either side of apparatus 720, a single arm connector design can also be used (e.g., where apparatus 720 is smaller).

Novel aspects directed towards vehicles configured to be used in conjunction with apparatus 720 are also disclosed. For instance, because it is anticipated that apparatus 720 may be loaded/unloaded onto a pickup truck, particular designs directed towards configuring the bed of a truck to facilitate such loading/unloading are contemplated. For example, the attachment, use, and design of extendible arms 714 may be configured to incorporate novel designs directed towards facilitating the loading/unloading of apparatus 720. Such designs may include manufacturing extendible arms 714 using material having properties which can hold particularly heavy objects. Extendible arms 714 may also be configured to include a novel locking mechanism for keeping apparatus 720 in place during transit. The loading of multiple apparatus 720 items onto a vehicle is also contemplated, wherein extendible arms 714 may be configured to receive and/or lock a first apparatus 720, as well as a subsequent apparatus 720.

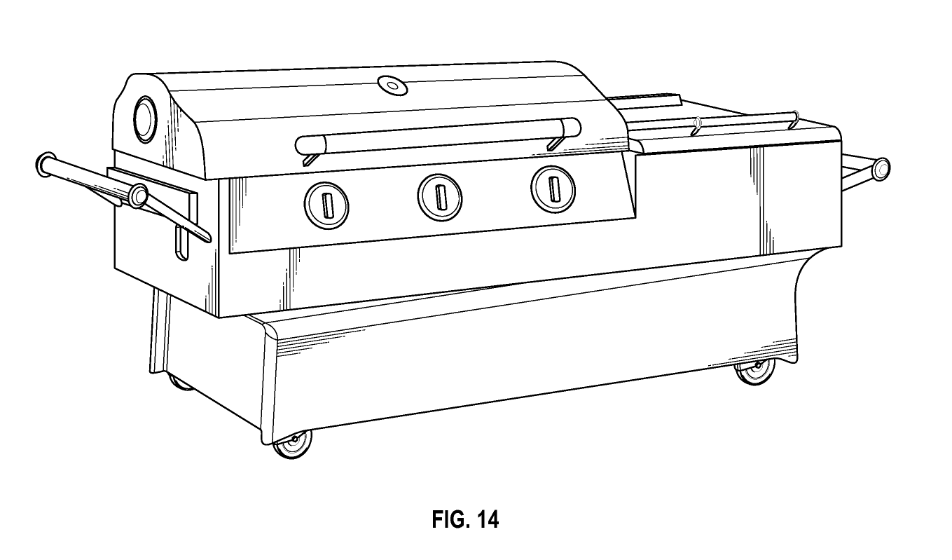

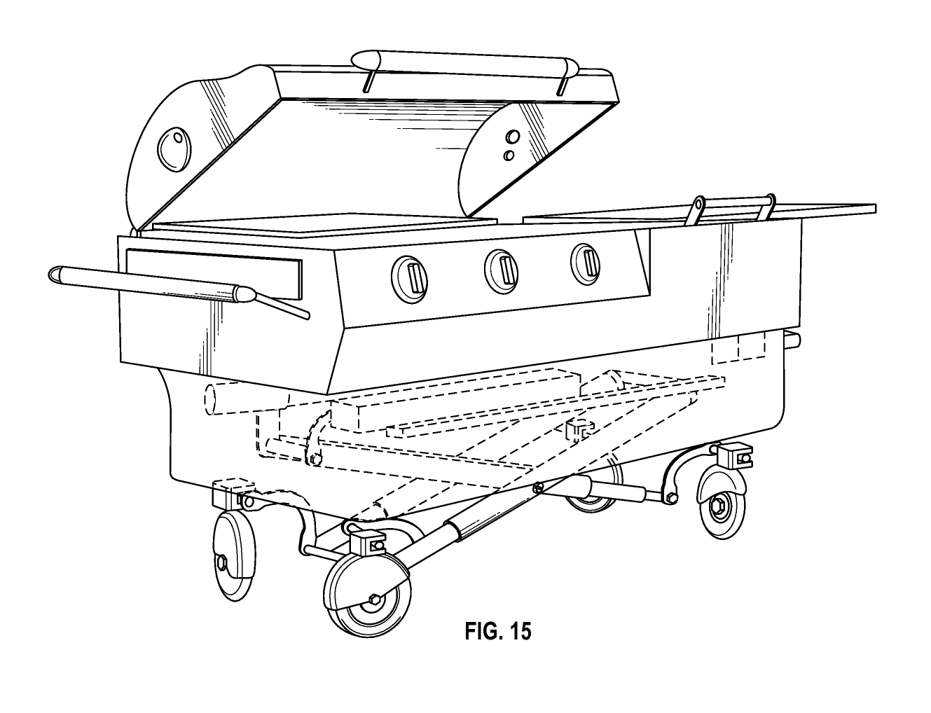

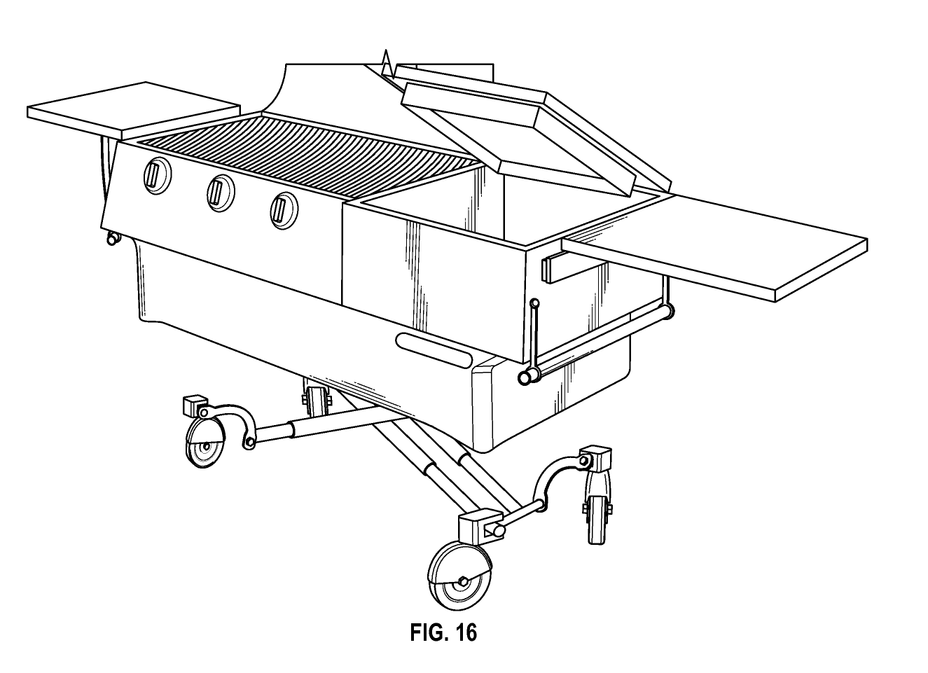

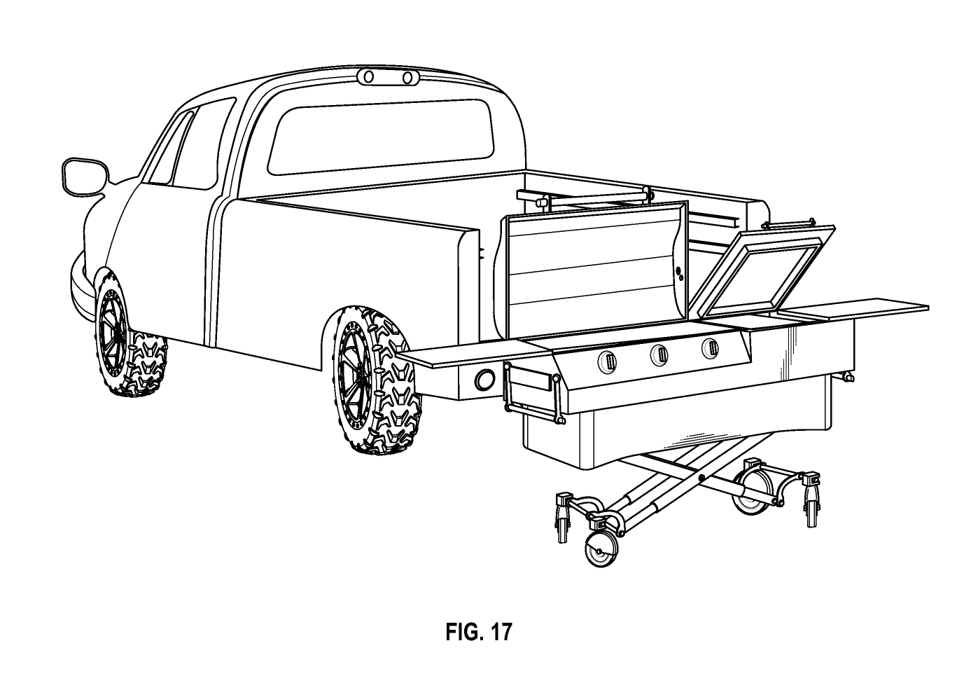

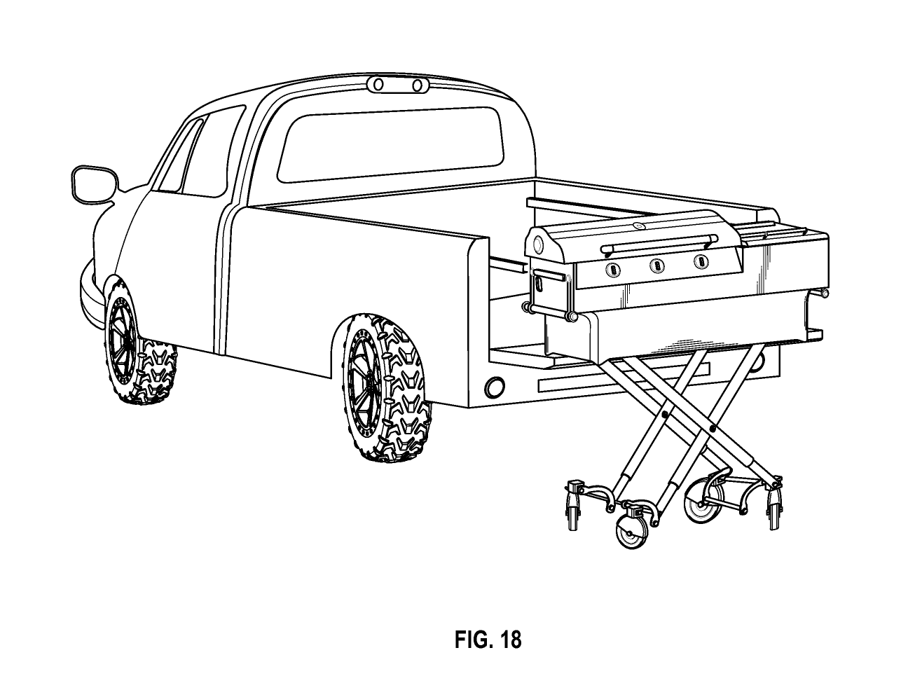

As previously mentioned, it is contemplated that the aspects disclosed herein also encompass methods and apparatuses configured to transport any of various items that may be bulky and/or heavy. In FIGS. 14-18, for instance, an exemplary barbecue grill in accordance with an aspect of the subject specification is provided. Here, although such embodiment is substantially similar to apparatus 720, rather than configuring the upper portion of apparatus 720 as a tool chest, the upper portion is configured as a barbecue grill having arm connectors on either side substantially similar to arm connectors 726. Indeed, a first view of an exemplary grill in a lowered configuration is provided in FIG. 14, whereas FIG. 15 illustrates the extendible legs of such lowered grill in a collapsed configuration. For this particular embodiment, the grill apparatus is thus configured as a gurney-like apparatus similar to apparatus 720, wherein the extendible legs can be raised, as illustrated in FIG. 16. Moreover, it is contemplated that the grill apparatus may be configured to be loaded onto a vehicle via a mechanism substantially similar to apparatus 720. In FIG. 17, for instance, an exemplary grill in a partially raised configuration is shown proximate to a tailgate, whereas FIG. 19 a fully raised configuration of such grill proximate to a tailgate.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components coupled to other components rather than included within parent components (hierarchical). Additionally, it is noted that one or more components may be combined into a single component providing aggregate functionality or divided into several separate sub-components, and any one or more middle layers may be provided to couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the various figures. While for purposes of simplicity of explanation, the methodologies are described as a series of steps, it is to be understood and appreciated that the disclosed subject matter is not limited by the order of the steps, as some steps may occur in different orders and/or concurrently with other steps from what is described herein. Moreover, not all disclosed steps may be required to implement the methodologies described hereinafter.

While the various embodiments have been described in connection with the exemplary embodiments of the various figures, it is to be understood that other similar embodiments may be used or modifications and additions may be made to the described embodiment for performing the same function without deviating there from. Therefore, the present invention should not be limited to any single embodiment.

1. An apparatus to facilitate mobilizing a load comprising:
a bed coupled to extendible legs, wherein
the extendible legs are configured to extend away from the bed in a first position and collapse towards the bed in a second position, the extendible legs comprising a lift component configured to facilitate a lifting of the bed to a desired height level; and
the bed comprises a vehicle attachment component configured to attach to a vehicle, the vehicle attachment component further configured to facilitate a transfer of weight of the apparatus from the extendible legs to the vehicle attachment component.

2. The apparatus of claim 1, wherein the bed further comprises a load stabilization component configured to stabilize the load on the bed.

3. The apparatus of claim 2, wherein the load stabilization component comprises at least one foldable flap configured to block a slippage of the load.

4. The apparatus of claim 2, wherein the load stabilization component comprises at least one latch configured to attach to the load.

5. The apparatus of claim 1, wherein the lift component comprises a hydraulic lift system.

6. The apparatus of claim 1, wherein the lift component comprises a manual crank system.

7. The apparatus of claim 1, wherein the lift component comprises a spring system.

8. The apparatus of claim 1, wherein the extendible legs further comprise a lock component configured to lock the extendible legs in at least one of the first position or the second position.

9. The apparatus of claim 8, wherein the lock component is configured to lock the extendible legs in a suspended position.

10. The apparatus of claim 1, wherein the vehicle attachment component is on a bottom portion of the bed.

11. The apparatus of claim 1, wherein the vehicle attachment component is on a side portion of the bed.

12. A vehicle comprising:
an extendible arm component coupled to an arm housing component, wherein
the arm housing component is configured to house the extendible arm component; and
the extendible arm component comprises at least one extendible arm configured to extend away from the arm housing component in a first position and retract into the arm housing component in a second position, the at least one extendible arm further configured to attach to a load and facilitate holding the load in a suspended position.

13. The apparatus of claim 12, wherein the at least one extendible arm is configured to mate with an attachment mechanism on the load.

14. The apparatus of claim 13, wherein the at least one extendible arm includes a male insert configured to mate with the attachment mechanism on the load.

15. The apparatus of claim 13, wherein the at least one extendible arm includes a female receptor configured to mate with the attachment mechanism on the load.

16. The apparatus of claim 12, further comprising a lock component configured to lock the at least one extendible arm in the first position.

17. The apparatus of claim 12, further comprising a lock component configured to lock the at least one extendible arm in the second position.

18. The apparatus of claim 12, wherein the extendible arm component is on a side portion of the vehicle.

19. The apparatus of claim 12, wherein the extendible arm component is on an inner portion of the vehicle.

20. A method to comprising:
ascertaining parameters associated with loading a load onto a vehicle;
determining a placement configuration of an arm component onto the vehicle according to the parameters, the arm component including at least one arm housing unit and at least one extendible arm; and
attaching the arm component onto the vehicle according to the placement configuration, wherein the attaching facilitates holding the load in a suspended position from the arm component.
